(19) United States
(12) Patent Application Publication
(10) Pub. No.: US 2022/0390961 A1
(43) Pub. Date: Dec. 8, 2022

(54) DRONE CONTROL USING BRAIN EMULATION NEURAL NETWORKS

(71) Applicant: X Development LLC, Mountain View, CA (US)

(72) Inventors: Sarah Ann Laszlo, Mountain View, CA (US); Jeffrey Bush, Los Altos, CA (US); Doris Tang, San Francisco, CA (US)

(21) Appl. No.: 17/341,832

(22) Filed: Jun. 8, 2021

(51) Int. Cl. G05D 1/10; G06N 3/04; G06N 3/08; G08G 5/00; G05D 1/00

(52) U.S. Cl. CPC G05D 1/101; G06N 3/04; G06N 3/08; G08G 5/0047; G05D 1/0088

(57) ABSTRACT

Methods, systems, and apparatus, including computer programs encoded on a computer storage medium, for receiving, at each of multiple time steps, sensor data captured by an onboard sensor of a drone at the time step, providing an input including the sensor data to a drone control neural network having a brain emulation sub-network with an architecture that is specified by synaptic connectivity between neurons in a brain of a biological organism, including instantiating a respective artificial neuron in the brain emulation sub-network corresponding to each of multiple biological neurons in the brain of the biological organism, and instantiating a respective connection between each pair of artificial neurons, processing the input using the drone control neural network to generate an action selection output, and selecting an action to be performed to control the drone at the time step based on the action selection output.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a drone control system implemented as computer programs on one or more computers in one or more locations such that streams of data generated by gyroscopic sensors of a drone to generate flight controls using a neural network, referred to herein as a drone control neural network. The drone control neural network can have a reservoir computing neural network architecture with a brain emulation neural network acting as the reservoir, referred to herein as a “brain emulation” sub-network, which is derived from a synaptic connectivity graph representing synaptic connectivity in the brain of a biological organism. The drone control neural network may be configured to process sensor data captured by drones to perform any of a variety of prediction tasks, e.g., to generate control signals for landing the drone.

As used within this specification, a drone, also known as an unmanned aerial vehicle (UAV), uncrewed aerial vehicle, unmanned aircraft, or uncrewed aircraft (UA), is generally an aircraft without a human pilot onboard. A drone can be fully autonomous or partially autonomous, e.g., where operations of the drone can be controlled by a remote pilot.

Gyroscopic data collected by onboard gyroscopes of a drone generally includes a measure of angular velocity and acceleration of a body (e.g., the drone) including the gyroscope.

Though the techniques described herein can be used to process gyroscopic information for control of a drone, e.g., to stabilize the drone during flight and/or to cause the drone to safely navigate to specified destinations, the drone control neural network can be utilized to process other forms of sensor data (e.g., positional data, wind data, temperature/humidity data, etc.) to perform a variety of prediction tasks.

Throughout this specification, a “neural network” refers to an artificial neural network, i.e., that is implemented by one or more computers. For convenience, a neural network having an architecture derived from a synaptic connectivity graph may be referred to as a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that may be performed by the neural network or otherwise implicitly characterizing the neural network.

According to a first aspect there is provided a method performed by one or more data processing apparatus for controlling a drone navigating in an environment including, at each of multiple time steps: receiving sensor data captured by an onboard sensor of a drone at the time step, providing an input including the sensor data to a drone control neural network having a brain emulation sub-network with an architecture that is specified by synaptic connectivity between neurons in a brain of a biological organism. Specifying the brain emulation sub-network architecture includes instantiating a respective artificial neuron in the brain emulation sub-network corresponding to each biological neuron of a plurality of biological neurons in the brain of the biological organism and instantiating a respective connection between each pair of artificial neurons in the brain emulation sub-network that correspond to a pair of biological neurons in the brain of the biological organism that are connected by a synaptic connection. The methods further include processing the input include the sensor data using the drone control neural network having the brain emulation sub-network to generate an action selection output, and selecting an action to be performed to control the drone at the time step based on the action selection output.

These and other embodiments can each optionally include one or more of the following features. In some implementations, the onboard sensor includes a gyroscope and the sensor data includes gyroscopic data, where the gyroscopic data can include an amplitude of displacement, an amplitude of velocity, and an amplitude of acceleration.

In some implementations, the drone control neural network includes an input sub-network, where processing the input including the sensor data using the drone control neural network can include processing the sensor data using the input sub-network to generate an embedding of the sensor data, and providing the embedding of the sensor data to the brain emulation sub-network of the drone control neural network.

In some implementations, the drone control neural network includes an output sub-network, where processing the input including the sensor data using the drone control neural network further includes processing the embedding of the sensor data using the brain emulation sub-network to generate an alternative representation of the sensor data, and processing the alternative representation of the sensor data using the output sub-network to generate the action selection output.

In some implementations, the methods further include receiving a respective reward at each of the multiple time steps that characterizes a performance of the drone in accomplishing a task, and training the input sub-network and the output sub-network of the drone control neural network based on the rewards using reinforcement learning techniques. The task can include navigating to a specified destination, hovering at a specified location, or landing in a specified landing area.

In some implementations, the task is landing in the specified landing area, where the respective reward received at each of the multiple time steps when the drone lands in the specified landing area is based on a proximity of a landing position of the drone to a center of the specified landing area.

In some implementations, the methods further include identifying a respective target action selection output at each of the multiple time steps, and training the input sub-network and the output sub-network of the drone control neural network to generate a respective action selection output at each time step that matches the target action selection output for the time step.

In some implementations, the action selection output includes a respective score for each action in a set of possible actions that can be performed by the drone. Selecting the action to be performed to control the drone at the time step based on the action selection output can include selecting an action corresponding to a highest score in the action selection output.

In some implementations, the action selection output defines an action that can be performed by the drone, where selecting the action to be performed to control the drone at the time step based on the action selection output includes selecting the action that is defined by the action selection output as the action to be performed to control the drone at the time step.

In some implementations, the action to be performed to control the drone at the time step includes an action to control a respective speed, tip/tilt, or rotation direction of one or more propellers of the drone.

In some implementations, the action selection output defines a course correction to a flight path of the drone, where selecting the action to be performed by the drone at the time step based on the action selection output includes selecting an action to be performed by the drone to achieve the course correction to the flight path of the drone.

In some implementations, specifying the brain emulation sub-network architecture further includes, for each pair of artificial neurons in the brain emulation sub-network that are connected by a respective connection: instantiating a weight value for the connection based on a proximity of a pair of biological neurons in the brain of the biological organism that correspond to the pair of artificial neurons in the brain emulation sub-network. The weight values of the brain emulation sub-network can be static during training of the drone control neural network.

In some implementations, the drone control neural network is implemented by an onboard computer system of the drone. The environment can be a simulated environment.

According to another aspect there are provided one or more non-transitory computer storage media storing instructions that when executed by one or more computers cause the one or more computers to perform the operations of the systems described herein.

According to another aspect there is provided a system comprising one or more computers and one or more storage devices storing instructions that when executed by the one or more computers cause the one or more computers to implement methods performed by one or more data processing apparatus for performing the operations of the systems described herein.

Particular embodiments of the subject matter described in this specification can be implemented so as to realize one or more of the following advantages.

An advantage of this technology is that the processing of gyroscopic sensor data (e.g., real-time data captured by gyroscopic sensors onboard a drone) can be performed by the brain emulation sub-network and can achieve significant (e.g., two-fold) reduction in power consumption, e.g., as compared to conventional drone control systems. A reduction in power consumption can reduce weight requirements associated with onboard power supplies, e.g., batteries and/or renewable power sources, such that an overall weight of the drone can be reduced. Utilizing the brain emulation neural sub-network to perform processing of gyroscopic data captured by an onboard sensor can result in a substantial improvement in processing speed over conventional drone control systems, e.g., resulting in a 3x improvement in processing speed over conventional drone control systems, such that the system can be utilized to adjust in real-time to unexpected hazards (e.g., safe vs unsafe landing zones), perform course correction (e.g., adjust in real-time to wind, obstructions, etc.), and provide real-time control signals to the drone.

The system described in this specification can process data streams captured by onboard sensors on a drone using a drone control neural network to generate a prediction characterizing the sensor data, for example, determine an action to adjust operation of the drone, e.g., a control signal to adjust operation of the drone propeller. The characterized sensor data can be utilized, e.g., to land the drone within a safe landing area and within a threshold performance requirement (e.g., touch-down speed, drone orientation at landing, etc.). The reservoir computing neural network includes a brain emulation sub-network that is derived from a synaptic connectivity graph representing synaptic connectivity in the brain of a biological organism. The brain of the biological organism may be adapted by evolutionary pressures to be effective at solving certain tasks. For example, in contrast to many conventional computer navigation systems, a biological brain may process gyroscopic data to generate control signals for controlling navigation of the drone, e.g., landing the drone, that may insensitive to and/or robust in light of factors such as sudden changes in wind, air pressure, unexpected hazards, etc., characterized by the sensor data. The brain emulation sub-network may inherit the capacity of the biological brain to effectively solve tasks (in particular, navigation/flight control processing tasks), and thereby enable the control system to perform sensor processing tasks more effectively, e.g., with higher accuracy.

The brain emulation sub-network of the drone control neural network may have a very large number of parameters and a highly recurrent architecture, i.e., as a result of being derived from a synaptic connectivity graph representing synaptic connectivity in the brain of a biological organism. Therefore, training the brain emulation sub-network using machine learning techniques may be computationally-intensive and prone to failure. Rather than training the brain emulation sub-network, the drone control system may utilize determined parameter values of the brain emulation sub-network based on the predicted strength of connections between corresponding neurons in the biological brain. The strength of the connection between a pair of neurons in the biological brain may characterize, e.g., the amount of information flow through a synapse connecting the neurons. In this manner, the drone control system may harness the capacity of the brain emulation sub-network, e.g., to generate representations that are effective for processing sensor data, without requiring the brain emulation sub-network to be trained. By refraining from training the brain emulation sub-network, the drone control system may reduce consumption of computational resources, e.g., memory and computing power, during training of the reservoir computing neural network.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example data flow for generating a synaptic connectivity graph representing synaptic connectivity between neurons in the brain of a biological organism.

FIG. 2 shows an example drone control system.

FIG. 3 shows an example operating environment of the drone control system.

FIG. 4 shows an example architecture selection system for generating a brain emulation neural network.

FIG. 5 is a flow diagram of an example process for processing sensor data using a reservoir computing neural network to generate a prediction characterizing the sensor data.

FIG. 6 is a block diagram of an example computer system.

Like reference numbers and designations in the various drawings indicate like elements.

### DETAILED DESCRIPTION

Sensor data captured by onboard sensors, e.g., gyroscopic data captured by onboard gyroscopes, located on a drone can be processed in real-time by a brain emulation neural network to generate an alternative representation of the gyroscopic data. The alternative representation can implicitly characterize an aspect of operation of the drone, e.g., a wing speed or position/direction of motion for the drone. The alternative representation of the gyroscopic data can be provided to a secondary neural network, e.g., an output sub-network, to generate control signals for drone operation that correspond to the output of the brain emulation neural network, e.g., course correction, propeller operation (for each propeller), etc., that would correspond to the wing speed or position/direction of movement. In one example, the secondary neural network may be trained using reinforcement learning training techniques to infer control signals for course correction corresponding to the output of the brain emulation neural network.

In some embodiments, the control signals for course correction can be utilized by a navigation system of a drone to land a drone safely. Landing a drone safely can include, for example, a threshold speed at which the drone comes in contact with a landing space. In another example, landing the drone safely includes landing the drone within an area designated as a safe landing zone (or within a threshold distance of a center point of the area designated as the safe landing zone). In another example, landing the drone safely includes an orientation of the drone when the drone comes in contact with a landing space, for example, such that respective parts of the landing gear of the drone touchdown within a threshold amount of time of each other and/or a range of deviation angles from a defined (perpendicular) axis of the drone.

In some embodiments, multiple brain emulation neural networks can be utilized, where each of the brain emulation neural networks is selected to process a different category of gyroscopic data, e.g., amplitude of displacement, velocity of displacement, and acceleration of displacement, etc.

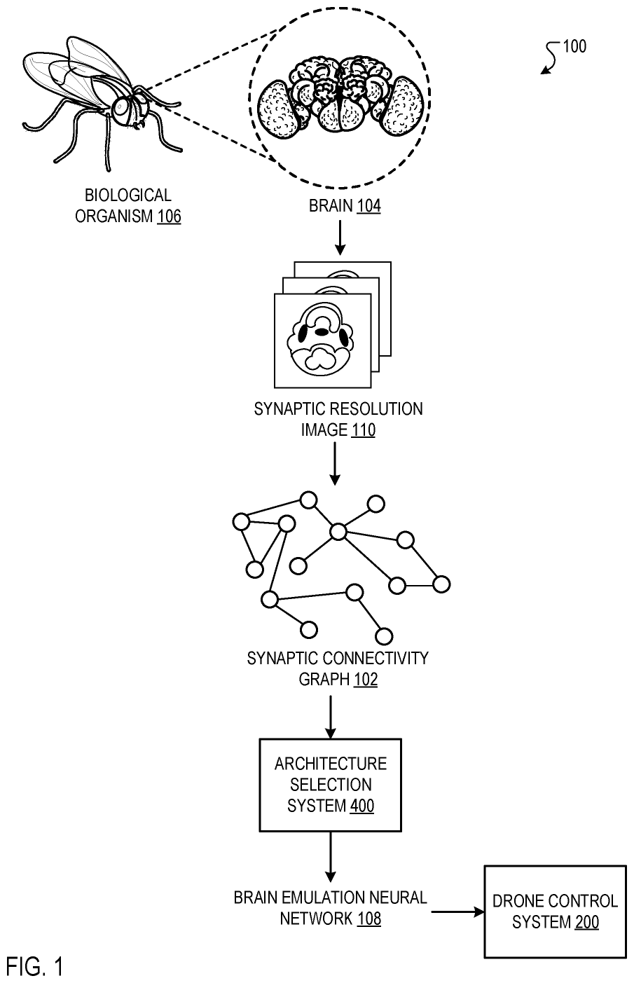

FIG. 1 shows an example data flow 100 for generating a synaptic connectivity graph 102 representing synaptic connectivity between neurons in the brain 104 of a biological organism 106. As used throughout this document, a brain may refer to any amount of nervous tissue from a nervous system of a biological organism, and nervous tissue may refer to any tissue that includes neurons (i.e., nerve cells). The biological organism 106 may be, e.g., a worm, a fly, a mouse, a cat, or a human.

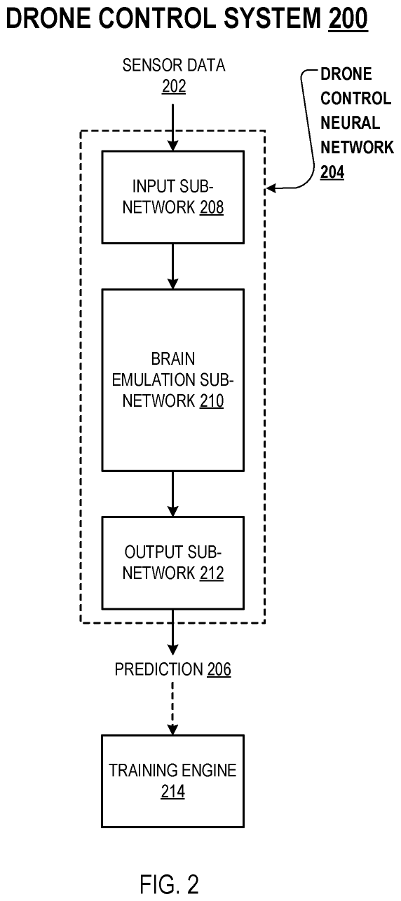

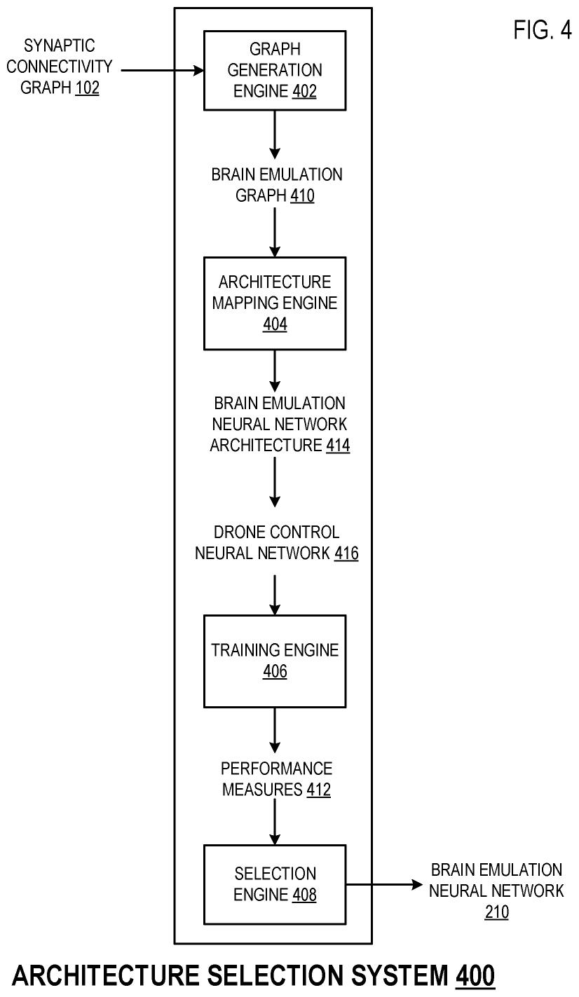

An architecture selection system 400 processes the synaptic connectivity graph 102 to generate a brain emulation neural network 108, and a drone control system 200 uses the brain emulation neural network for processing sensor data captured by an onboard sensor of a drone. An example drone control system 200 is described in more detail with reference to FIG. 2, and an example architecture selection system 400 is described in more detail with reference to FIG. 4.

An imaging system may be used to generate a synaptic resolution image 110 of the brain 104. An image of the brain 104 may be referred to as having synaptic resolution if it has a spatial resolution that is sufficiently high to enable the identification of at least some synapses in the brain 104. Put another way, an image of the brain 104 may be referred to as having synaptic resolution if it depicts the brain 104 at a magnification level that is sufficiently high to enable the identification of at least some synapses in the brain 104. The image 110 may be a volumetric image, i.e., that characterizes a three-dimensional representation of the brain 104. The image 110 may be represented in any appropriate format, e.g., as a three-dimensional array of numerical values.

The imaging system may be any appropriate system capable of generating synaptic resolution images, e.g., an electron microscopy system. The imaging system may process “thin sections” from the brain 104 (i.e., thin slices of the brain attached to slides) to generate output images that each have a field of view corresponding to a proper subset of a thin section. The imaging system may generate a complete image of each thin section by stitching together the images corresponding to different fields of view of the thin section using any appropriate image stitching technique. The imaging system may generate the volumetric image 110 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system may be used to process the synaptic resolution image 110 to generate the synaptic connectivity graph 102. The synaptic connectivity graph 102 specifies a set of nodes and a set of edges, such that each edge connects two nodes. To generate the graph 102, the graphing system identifies each neuron in the image 110 as a respective node in the graph, and identifies each synaptic connection between a pair of neurons in the image 110 as an edge between the corresponding pair of nodes in the graph.

The graphing system may identify the neurons and the synapses depicted in the image 110 using any of a variety of techniques. For example, the graphing system may process the image 110 to identify the positions of the neurons depicted in the image 110, and determine whether a synapse connects two neurons based on the proximity of the neurons (as will be described in more detail below). In this example, the graphing system may process an input including: (i) the image, (ii) features derived from the image, or (iii) both, using a machine learning model that is trained using supervised learning techniques to identify neurons in images. The machine learning model may be, e.g., a convolutional neural network model or a random forest model. The output of the machine learning model may include a neuron probability map that specifies a respective probability that each voxel in the image is included in a neuron. The graphing system may identify contiguous clusters of voxels in the neuron probability map as being neurons.

Optionally, prior to identifying the neurons from the neuron probability map, the graphing system may apply one or more filtering operations to the neuron probability map, e.g., with a Gaussian filtering kernel. Filtering the neuron probability map may reduce the amount of “noise” in the neuron probability map, e.g., where only a single voxel in a region is associated with a high likelihood of being a neuron.

The machine learning model used by the graphing system to generate the neuron probability map may be trained using supervised learning training techniques on a set of training data. The training data may include a set of training examples, where each training example specifies: (i) a training input that can be processed by the machine learning model, and (ii) a target output that should be generated by the machine learning model by processing the training input. For example, the training input may be a synaptic resolution image of a brain, and the target output may be a “label map” that specifies a label for each voxel of the image indicating whether the voxel is included in a neuron. The target outputs of the training examples may be generated by manual annotation, e.g., where a person manually specifies which voxels of a training input are included in neurons.

Example techniques for identifying the positions of neurons depicted in the image 110 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system may identify the synapses connecting the neurons in the image 110 based on the proximity of the neurons. For example, the graphing system may determine that a first neuron is connected by a synapse to a second neuron based on the area of overlap between: (i) a tolerance region in the image around the first neuron, and (ii) a tolerance region in the image around the second neuron. That is, the graphing system may determine whether the first neuron and the second neuron are connected based on the number of spatial locations (e.g., voxels) that are included in both: (i) the tolerance region around the first neuron, and (ii) the tolerance region around the second neuron. For example, the graphing system may determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron may be specified as the set of spatial locations in the image that are either: (i) in the interior of the neuron, or (ii) within a predefined distance of the interior of the neuron.

The graphing system may further identify a weight value associated with each edge in the graph 102. For example, the graphing system may identify a weight for an edge connecting two nodes in the graph 102 based on the area of overlap between the tolerance regions around the respective neurons corresponding to the nodes in the image 110. The area of overlap may be measured, e.g., as the number of voxels in the image 110 that are contained in the overlap of the respective tolerance regions around the neurons. The weight for an edge connecting two nodes in the graph 102 may be understood as characterizing the (approximate) strength of the connection between the corresponding neurons in the brain (e.g., the amount of information flow through the synapse connecting the two neurons).

In addition to identifying synapses in the image 110, the graphing system may further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system determines the directions of the synapses in the image 110, the graphing system may associate each edge in the graph 102 with direction of the corresponding synapse. That is, the graph 102 may be a directed graph. In other implementations, the graph 102 may be an undirected graph, i.e., where the edges in the graph are not associated with a direction.

The graph 102 may be represented in any of a variety of ways. For example, the graph 102 may be represented as a two-dimensional array of numerical values, referred to as an “adjacency matrix”, with a number of rows and columns equal to the number of nodes in the graph. The component of the array at position (i, j) may have value 1 if the graph includes an edge pointing from node i to node j, and value 0 otherwise. In implementations where the graphing system determines a weight value for each edge in the graph 102, the weight values may be similarly represented as a two-dimensional array of numerical values. More specifically, if the graph includes an edge connecting node i to node j, the component of the array at position (i,j) may have a value given by the corresponding edge weight, and otherwise the component of the array at position (i, j) may have value 0.

The architecture selection system 400 processes the synaptic connectivity graph 102 to generate a brain emulation neural network 108. The architecture selection system may determine the neural network architecture of the brain emulation neural network by searching a space of possible neural network architectures. The architecture selection system 400 may seed (i.e., initialize) the search through the space of possible neural network architectures using the synaptic connectivity graph 102 representing synaptic connectivity in the brain 104 of the biological organism 106. An example architecture selection system 400 is described in more detail with reference to FIG. 4.

The drone control system 200 uses the brain emulation neural network 108 to process sensor data to generate predictions, as will be described in more detail next.

FIG. 2 shows an example drone control system 200. The drone control system 200 is an example of a system implemented as computer programs on one or more computers in one or more locations in which the systems, components, and techniques described below are implemented.

The system 200 is configured to process sensor data 202, e.g., gyroscopic data collected by an onboard gyroscope on a drone, using a drone control neural network 204 to generate a prediction 206 characterizing the sensor data 202.

The sensor data 202 may be captured by an onboard measurement device located on a drone. For example, sensor data 202 can be gyroscopic data captured by an onboard gyroscope of a drone. The sensor data 202 may be represented, e.g., as an array of numerical values.

In some implementations, sensor data 202 can include multiple streams of sensor data captured by multiple onboard measurement devices located onboard a drone, for example, multiple gyroscopes at different locations on the drone generating respective streams of gyroscopic data. Each stream of sensor data 202 can be represented, e.g., by a respective array of numerical values.

In some implementations, sensor data 202 includes a time series generated by the sensor for a given sampling time period and at a given sampling rate. In other words, sensor data 202 can be measurements captured by an onboard gyroscope of the drone for a period of time, e.g., 5 seconds, 10 seconds, 2 seconds, etc., and which is sampled from the onboard gyroscope at a sampling rate, e.g., between 5 and 40 kHz, e.g., between 8 and 32 kHz, etc. Captured measurements by the onboard gyroscope can be utilized as sensor data 202 that is provided to the drone control neural network 204 as input.

The drone control neural network 204 includes: (i) an input sub-network 208, (ii) a brain emulation sub-network 210, and (iii) an output sub-network 212, each of which will be described in more detail next. Throughout this specification, a “sub-network” refers to a neural network that is included as part of another, larger neural network.

In some implementations, any one of the input sub-network, the output sub-network, or some other trained sub-network of the drone control neural network can include one or more recurrent neural network layers, e.g., long short-term memory (LSTM) neural network layers.

Sensor data 202 is provided as input to the input sub-network 208. The input sub-network 208 is configured to process the sensor data 202 to generate an embedding of the sensor data 202, i.e., a representation of the sensor data 202 as an ordered collection of numerical values, e.g., a vector, tensor, or matrix of numerical values. The input sub-network may have any appropriate neural network architecture that enables it to perform its described function, e.g., a neural network architecture that includes a single fully-connected neural network layer.

In some implementations, the input sub-network 208 is configured to generate an embedding of the sensor data 202, e.g., multiple vectors, tensors, or matrices of numerical values, where each vector, tensor, or matrix corresponds to an input channel of sensor data from an onboard sensor of the drone. In one example, an onboard sensor is a gyroscope generating multiple channels of gyroscopic data, e.g., amplitude of displacement, amplitude of velocity, and amplitude of acceleration. Each of the multiple channels of gyroscopic data captured by the gyroscope can be utilized to generate a respective embedding, e.g., vector, tensor, or matrix of numerical values, by the input sub-network 208.

The brain emulation sub-network 210 is configured to process the embedding of the sensor data 202 (i.e., that is generated by the input sub-network) to generate an alternative representation of the sensor data, for example, as an ordered collection of numerical values, e.g., a vector, tensor, or matrix of numerical values. The architecture and parameter values of the brain emulation sub-network 210 are derived from a synaptic connectivity graph representing synaptic connectivity in the brain of a biological organism. The brain emulation sub-network 210 may be generated, e.g., by an architecture selection system, which will be described in more detail with reference to FIG. 4.

The output sub-network 212 is configured to process the alternative representation of the sensor data (i.e., that is generated by the brain emulation sub-network 210) to generate the prediction 206 characterizing the sensor data 202. The output sub-network 212 may have any appropriate neural network architecture that enables it to perform its described function, e.g., a neural network architecture that includes a single fully-connected layer.

In some cases, the brain emulation sub-network 210 may have a recurrent neural network architecture, i.e., where the connections in the architecture define one or more “loops.” More specifically, the architecture may include a sequence of components (e.g., artificial neurons, layers, or groups of layers) such that the architecture includes a connection from each component in the sequence to the next component, and the first and last components of the sequence are identical. In one example, two artificial neurons that are each directly connected to one another (i.e., where the first neuron provides its output the second neuron, and the second neuron provides its output to the first neuron) would form a recurrent loop.

A recurrent brain emulation sub-network may process a sensor data embedding (i.e., one or more vectors, tensors, or matrices generated by the input sub-network) over multiple (internal) time steps to generate a respective network output at each time step. In particular, at each time step, the brain emulation sub-network may process: (i) the sensor data embedding, and (ii) one or more outputs generated by the brain emulation sub-network at the preceding time step, to generate the brain emulation sub-network output for the time step. The drone control neural network 204 may provide the network output generated by the brain emulation sub-network at the final time step as the input to the output sub-network 212. The number of time steps over which the brain emulation sub-network 210 processes the sensor data embedding may be a predetermined hyper-parameter of the drone control system 200.

In some implementations, the output sub-network 212 is configured to receive an intermediate output from the brain emulation sub-network 210. An intermediate output refers to an output generated by a hidden artificial neuron of the brain emulation sub-network, i.e., an artificial neuron that is not included in the input layer or the output layer of the brain emulation sub-network.

The output sub-network 212 can process the output generated by the brain emulation sub-network 210 (i.e., the alternative representation of the sensor data) to generate a corresponding action selection output.

In some implementations, the action selection output can include a respective score corresponding to each action in a set of possible actions. In one example, each action can define, for each propeller of the drone, a respective rotational speed for the propeller, a respective tilt of the propeller, or both. In another example, each action can define a respective adjustment to the flight direction of the drone (e.g., where the flight direction of the drone can be represented as three-dimensional (3-D) vector defining the flight direction of the drone in x-y-z coordinates), an adjustment to the 3-D orientation/tilt of the drone, or both.

In some implementations, the action selection output can directly define an action to be performed by the drone. For example, the action selection output can define a respective propeller speed and tilt angle for each propeller on the drone.

At each of multiple time steps (e.g., every 0.1 seconds, or at any other appropriate time steps), the drone control system 200 can process sensor data 202 for the time step (e.g., gyroscopic data generated at the time step) to generate an action selection output. The drone control system 200 can select an action to be performed by the drone at the time step based on the action selection output. For example, the drone control system 200 can select the action having the highest score (i.e., as defined by the action selection output). As another example, the drone control system 200 can sample a respective action from the set of possible actions in accordance with a probability distribution over the set of possible actions that is generated, e.g., by processing the action scores defined by the action selection output using a soft-max function.

After selecting the action to be performed at the time step, the drone control system 200 can use the selected action to control the operation of the drone at the time step. For example, if the selected action defines a respective speed for each propeller of the drone, then the drone control system 200 can change the respective speed of each propeller of the drone to match the speeds defined by the selected action, e.g., by generating control signals for each of the propellers. As another example, if the selected action defines an adjustment to the flight direction of the drone, then the drone control system 200 can adjust the propeller speeds of the drone to achieve the adjustment to the flight direction of the drone.

The drone control system 200 can use a training engine 214 to train at least the input/output sub-networks of the drone control neural network 204. In some implementations, the input sub-network and output sub-network can be trained to received sensor data and provide a corresponding control signal for operating the drone, e.g., operating a navigation system of a drone, while the brain emulation sub-network is not trained, i.e., such that the parameter values of the brain emulation sub-network 210 are held static during training. Training of the input sub-network and output sub-network can be performed, for example, using reinforcement learning or supervised learning. For example, the input/output sub-networks can be trained using reinforcement learning based on a reward signal that characterizes a progress of the drone in accomplishing a task. The task can be a navigation task, e.g., landing the drone at a specified landing area, navigating to a specified destination, hovering at a specified location, or reaching a location in the lowest possible amount of time or using the lowest possible amount of power. Training of the input/output sub-networks can be performed utilizing a simulated environment for the drone including simulated gyroscopic data responsive to simulated environmental conditions, e.g., wind, air pressure, etc.

The reinforcement learning technique can be any appropriate reinforcement learning technique, e.g., a Q learning technique or an actor critic technique. Training the drone control neural network using the reinforcement learning technique can encourage the selection of actions that maximize a cumulative measure of rewards (e.g., a time discounted sum of rewards) that are received as a result of using the drone control network to control the drone.

In some implementations, the reward received at each time step can be a binary numerical value, e.g., “0” and “1,” corresponding to an incomplete task and complete task, respectively. During training, a reward can be received at each time step based on the progress of the drone in performing its task. For example, the reward can be 0 at each time step until the drone completes the task, at which point the reward can be 1. In one example, a reward signal of “1” can be returned when the drone lands safely within a designated location (e.g., within a designated safe landing zone, less than a threshold landing speed, within a threshold angular deviation orientation with respect to a center (perpendicular) axis), and a reward signal of “0” otherwise.

In some implementations, a reward signal for training the input/output sub-networks can be a scalable value, e.g., between [0,1], corresponding to a proximity of landing the drone to a center point of a safe landing zone. A safe landing zone can be defined, for example, within image data captured by an onboard camera of the drone, e.g., using machine vision techniques, such that the input/output sub-networks can be trained to enable the drone control system to select actions that cause the drone to land safely within the designated safe landing zone. A scalable value can be assigned to the outcome of the landing, where an increasing value can be provided with a maximal value when the drone lands at a center point of the safe landing zone. As another example, if the drone control system is controlling the drone to perform a hovering task (e.g., that requires maintaining a target position of the drone, e.g., in a windy environment), then the reward at each time step can be a scalar value that depends on a distance of the drone from its target position. In particular, the reward can be inversely related to the distance of the drone from its target position, e.g., such that a higher reward is received at a time step where the drone is closer to its target position.

In addition to or as an alternative to the reinforcement learning training, the training engine 214 can also train the input/output sub-networks of the drone control neural network 204 using imitation learning techniques. For example, at each time step, the training engine 214 can use a conventional drone control system (e.g., based on proportional-integral-derivative (PID) controllers) to process the sensor data for the time step to generate a target action to be performed by the drone at the time step. The training engine 214 can then train the drone control neural network to process the sensor data for the time step to generate an action selection output that “matches” the target action, e.g., by assigning a high score to the target action. In some implementations, imitation learning training can be utilized in initially training the drone control neural network to perform a task by mimicking a conventional system, and then using the additional reinforcement learning training to improve on the conventional system.

In some implementations, training of the drone control neural network, e.g., the input/output sub-networks, can be performed in a simulation, e.g., by using the drone control neural network to control a simulated drone in a simulated environment. After training in the simulated environment, the drone control neural network can be used to control a drone in a real world environment, and additional training can be done on the more realistic real-world data.

The drone control system 200 may use a training engine 214 to train the drone control neural network 204, i.e., to enable the drone control neural network 204 to generate action selection outputs that enable the drone control system 200 to control the drone to effectively accomplish tasks. The training engine 214 may train the drone control neural network 204 on a set of training data that includes multiple trajectories that characterize interaction of the drone with an environment over a sequence of time steps. In particular, each trajectory can define, for each time step in a sequence of time steps: (i) sensor data captured by onboard sensors (e.g., gyroscopic sensors of the drone at the time step), (ii) a reward received at the time step (as described above), and (iii) optionally, a target action to be performed at the time step (as described above).

At each of multiple training iterations, the training engine 214 may sample a batch (i.e., set) of one or more trajectories from the training data, and process the respective sensor data for each time step in each trajectory using the drone control neural network 204 to generate a corresponding action selection output. The training engine 214 may determine gradients of an objective function with respect to the reservoir computing neural network parameters, where the objective function depends on the respective action selection output generated by the drone control neural network 204 for each time step in each trajectory. For example, for reinforcement learning training, the objective function can include, e.g., a Q learning objective function that further depends on the reward received at the time step. As another example, for imitation learning training, the objective function can include, e.g., a cross-entropy objective function that measures a cross-entropy error between: (i) the action selection output generated by the drone control neural network 204 for the time step, and (ii) the target action for the time step.

The training engine 214 may use the gradients of the objective function to update the values of the drone control neural network parameters (in particular, the parameters of the input/output sub-networks of the drone control neural network), e.g., to optimize the objective function. The training engine 214 may determine the gradients of the objective function with respect to the reservoir computing neural network parameters, e.g., using backpropagation or Hebbian learning techniques. The training engine 214 may use the gradients to update the reservoir computing neural network parameters using the update rule of a gradient descent optimization algorithm, e.g., Adam or RMSprop.

During training of the drone control neural network 204, the parameter values of the input sub-network 208 and the output sub-network 212 are trained, but some or all of the parameter values of the brain emulation sub-network 210 may be static, i.e., not trained. Instead of being trained, the parameter values of the brain emulation sub-network 210 may be determined from the weight values of the edges of the synaptic connectivity graph, as will be described in more detail below with reference to FIG. 4. Generally, the brain emulation sub-network may have a large number of parameters and a highly recurrent architecture as a result of being derived from the synaptic connectivity of a biological brain. Therefore training the brain emulation sub-network may be computationally-intensive and prone to failure, e.g., as a result of the parameter values of the brain emulation sub-network oscillating or diverging rather than converging to fixed values. The drone control neural network 204 may harness the capacity of the brain emulation sub-network, e.g., to generate representations that are effective for processing sensor data, without requiring the brain emulation sub-network to be trained.

The training engine 214 may use any of a variety of regularization techniques during training of the drone control neural network 204. For example, the training engine 214 may use a dropout regularization technique, such that certain artificial neurons of the brain emulation sub-network are “dropped out” (e.g., by having their output set to zero) with a non-zero probability p>0 each time the brain emulation sub-network processes an input. Using the dropout regularization technique may improve the performance of the trained drone control neural network 204, e.g., by reducing the likelihood of over-fitting. An example dropout regularization technique is described with reference to: N. Srivastava, et al.: “Dropout: a simple way to prevent neural networks from overfitting,” Journal of Machine Learning Research 15 (2014) 1929-1958. As another example, the training engine 214 may regularize the training of the drone control neural network 204 by including a “penalty” term in the objective function that measures the magnitude of the parameter values of the input sub-network 208, the output sub-network 212, or both. The penalty term may be, e.g., an L₁ or L₂ norm of the parameter values of the input sub-network 208, the output sub-network 212, or both.

In some cases, the values of the intermediate outputs of the brain emulation sub-network 210 may have large magnitudes, e.g., as a result of the parameter values of the brain emulation sub-network 210 being derived from the weight values of the edges of the synaptic connectivity graph rather than being trained. Therefore, to facilitate training of the drone control neural network 204, batch normalization layers may be included between the layers of the brain emulation sub-network 210, which can contribute to limiting the magnitudes of intermediate outputs generated by the brain emulation sub-network. Alternatively or in combination, the activation functions of the neurons of the brain emulation sub-network may be selected to have a limited range. For example, the activation functions of the neurons of the brain emulation sub-network may be selected to be sigmoid activation functions with range given by [0,1].

The example architecture of the drone control neural network that is described with reference to FIG. 2 is provided for illustrative purposes only, and other architectures of the drone control neural network are possible. For example, the drone control neural network may include a sequence of multiple different brain emulation sub-networks, e.g., each generated by the architecture selection system described with reference to FIG. 4. In this example, the brain emulation sub-networks may be interleaved with sub-networks having parameter values that are trained during the training of the drone control neural network, i.e., in contrast to the parameter values of the brain emulation sub-networks. Generally, a drone control neural network 204 includes: (i) one or more brain emulation sub-networks having parameter values derived from a synaptic connectivity graph, and (ii) one or more trainable sub-networks. The brain emulation sub-networks and the trainable sub-networks may be connected in any of a variety of configurations.

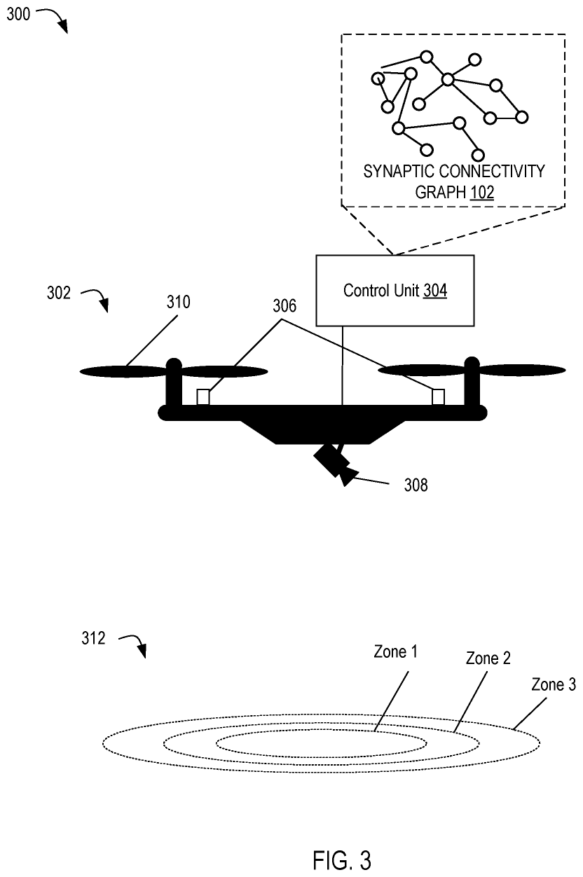

FIG. 3 shows an example operating environment 300 of the drone control system 200. As described above, a drone 302 can be, for example, a partially or fully autonomous uncrewed/unmanned aircraft. Drone 302 includes an onboard control unit 304 including one or more computers implementing one or more computer programs implementing the drone control system 200. In some implementations, drone control system 200 can be implemented as computer programs on one or more computers located onboard the drone 302, on one or more cloud-based servers (i.e., such that the drone provides sensor data to the system 200 in real-time to the cloud-based servers via a network for processing and receives back results of the processing), or a combination thereof. In one example, drone control system 200 is implemented as computer programs on one or more single-board computers, e.g., one or more Raspberry Pi boards or the like, located on the drone 302.

In some implementations, the control unit 304 can include wireless network connectivity, e.g., via satellite communication, Wi-Fi, etc., in data communication with a network. Drone 302 further includes sensors 306, e.g., gyroscope(s), altimeter, anemometer, temperature gauge, global positioning system (GPS), or the like, in data communication with control unit 304. In some implementations, drone 302 includes onboard camera 308 in data communication with control unit 304. Drone includes a navigation system including one or more propellers 310 which can have, for example, associated directions of rotation, tip/tilt, range of rotation speed, and the like. Navigation systems can additionally include, for example, landing gear, a rudder, stabilizers, flaps, etc., that can be utilized by the drone to control movement of the drone. Drone 302 can include on an onboard power source, e.g., a battery or renewable power source, configured to provide power to control unit 304, sensors 306, camera 308, and the navigation system including propellers 310.

A safe landing area 312 can be a landing space not including hazards, e.g., not including power lines, trees, roadways, etc., where the drone can land within the safe landing area 312 without causing harm to itself or another object, human, etc. Safe landing area 312 can include multiple zones, e.g., zone 1, zone 2, and zone 3, where the zones can define areas within the safe landing area 312 of varying degree landing desirability. In one example, zone 1 can represent a maximally desirable landing area within the safe landing area 312, and zone 3 can represent a least desirable landing area within the safe landing area 312. As described above with reference to FIG. 2, reinforcement learning of the output sub-network can include utilizing a reward signal having a scalable value depending on a proximity of the landing to a center of a safe landing area. In another example, a reward signal can have a scalable value depending on a zone, e.g., zone 1 vs zone 3, within which the drone lands.

FIG. 4 shows an example architecture selection system 400. The architecture selection system 400 is an example of a system implemented as computer programs on one or more computers in one or more locations in which the systems, components, and techniques described below are implemented.

The system 400 is configured to search a space of possible neural network architectures to identify the neural network architecture of a brain emulation neural network 108 to be included in a drone control neural network that processes sensor data, e.g., as described with reference to FIG. 2. The system 400 seeds the search through the space of possible neural network architectures using a synaptic connectivity graph 102 representing synaptic connectivity in the brain of a biological organism. The synaptic connectivity graph 102 may be derived directly from a synaptic resolution image of the brain of a biological organism, e.g., as described with reference to FIG. 1. In some cases, the synaptic connectivity graph 102 may be a sub-graph of a larger graph derived from a synaptic resolution image of a brain, e.g., a sub-graph that includes neurons of a particular type, e.g., visual neurons, association neurons.

The system 400 includes a graph generation engine 402, an architecture mapping engine 404, a training engine 406, and a selection engine 408, each of which will be described in more detail next.

The graph generation engine 402 is configured to process the synaptic connectivity graph 102 to generate multiple “brain emulation” graphs 410, where each brain emulation graph is defined by a set of nodes and a set of edges, such that each edge connects a pair of nodes. The graph generation engine 402 may generate the brain emulation graphs 410 from the synaptic connectivity graph 102 using any of a variety of techniques. A few examples follow.

In one example, the graph generation engine 402 may generate a brain emulation graph 410 at each of multiple iterations by processing the synaptic connectivity graph 102 in accordance with current values of a set of graph generation parameters. The current values of the graph generation parameters may specify (transformation) operations to be applied to an adjacency matrix representing the synaptic connectivity graph 102 to generate an adjacency matrix representing a brain emulation graph 410. The operations to be applied to the adjacency matrix representing the synaptic connectivity graph may include, e.g., filtering operations, cropping operations, or both. The brain emulation graph 410 may be defined by the result of applying the operations specified by the current values of the graph generation parameters to the adjacency matrix representing the synaptic connectivity graph 102.

The graph generation engine 402 may apply a filtering operation to the adjacency matrix representing the synaptic connectivity graph 102, e.g., by convolving a filtering kernel with the adjacency matrix representing the synaptic connectivity graph. The filtering kernel may be defined by a two-dimensional matrix, where the components of the matrix are specified by the graph generation parameters. Applying a filtering operation to the adjacency matrix representing the synaptic connectivity graph 102 may have the effect of adding edges to the synaptic connectivity graph 102, removing edges from the synaptic connectivity graph 102, or both.

The graph generation engine 402 may apply a cropping operation to the adjacency matrix representing the synaptic connectivity graph 102, where the cropping operation replaces the adjacency matrix representing the synaptic connectivity graph 102 with an adjacency matrix representing a sub-graph of the synaptic connectivity graph 102. The cropping operation may specify a sub-graph of synaptic connectivity graph 102, e.g., by specifying a proper subset of the rows and a proper subset of the columns of the adjacency matrix representing the synaptic connectivity graph 102 that define a sub-matrix of the adjacency matrix. The sub-graph may include: (i) each edge specified by the sub-matrix, and (ii) each node that is connected by an edge specified by the sub-matrix.

At each iteration, the system 400 determines a performance measure 412 corresponding to the brain emulation graph 410 generated at the iteration, and the system 400 updates the current values of the graph generation parameters to encourage the generation of brain emulation graphs 410 with higher performance measures 412. The performance measure 412 for a brain emulation graph 410 characterizes the performance of a reservoir computing neural network that includes a brain emulation neural network having an architecture specified by the brain emulation graph 410 at processing images to perform a task. Determining performance measures 412 for brain emulation graphs 410 will be described in more detail below. The system 400 may use any appropriate optimization technique to update the current values of the graph generation parameters, e.g., a “black-box” optimization technique that does not rely on computing gradients of the operations performed by the graph generation engine 402. Examples of black-box optimization techniques which may be implemented by the optimization engine are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters may be set to default values or randomly initialized.

In another example, the graph generation engine 402 may generate the brain emulation graphs 410 by “evolving” a population (i.e., a set) of graphs derived from the synaptic connectivity graph 102 over multiple iterations. The graph generation engine 402 may initialize the population of graphs, e.g., by “mutating” multiple copies of the synaptic connectivity graph 102. Mutating a graph refers to making a random change to the graph, e.g., by randomly adding or removing edges or nodes from the graph. After initializing the population of graphs, the graph generation engine 402 may generate a brain emulation graph at each of multiple iterations by, at each iteration, selecting a graph from the population of graphs derived from the synaptic connectivity graph and mutating the selected graph to generate a brain emulation graph 410. The graph generation engine 402 may determine a performance measure 412 for the brain emulation graph 410, and use the performance measure to determine whether the brain emulation graph 410 is added to the current population of graphs.

In some implementations, each edge of the synaptic connectivity graph may be associated with a weight value that is determined from the synaptic resolution image of the brain, as described above. Each brain emulation graph may inherit the weight values associated with the edges of the synaptic connectivity graph. For example, each edge in the brain emulation graph that corresponds to an edge in the synaptic connectivity graph may be associated with the same weight value as the corresponding edge in the synaptic connectivity graph. Edges in the brain emulation graph that do not correspond to edges in the synaptic connectivity graph may be associated with default or randomly initialized weight values.

In another example, the graph generation engine 402 can generate each brain emulation graph 410 as a sub-graph of the synaptic connectivity graph 102. For example, the graph generation engine 402 can randomly select sub-graphs, e.g., by randomly selecting a proper subset of the rows and a proper subset of the columns of the adjacency matrix representing the synaptic connectivity graph 102 that define a sub-matrix of the adjacency matrix. The sub-graph may include: (i) each edge specified by the sub-matrix, and (ii) each node that is connected by an edge specified by the sub-matrix.

The architecture mapping engine 404 processes each brain emulation graph 410 to generate a corresponding brain emulation neural network architecture 414. The architecture mapping engine 404 may use the brain emulation graph 410 derived from the synaptic connectivity graph 102 to specify the brain emulation neural network architecture 414 in any of a variety of ways. For example, the architecture mapping engine may map each node in the brain emulation graph 410 to a corresponding: (i) artificial neuron, (ii) artificial neural network layer, or (iii) group of artificial neural network layers in the brain emulation neural network architecture, as will be described in more detail next.

In one example, the brain emulation neural network architecture may include: (i) a respective artificial neuron corresponding to each node in the brain emulation graph 410, and (ii) a respective connection corresponding to each edge in the brain emulation graph 410. In this example, the brain emulation graph may be a directed graph, and an edge that points from a first node to a second node in the brain emulation graph may specify a connection pointing from a corresponding first artificial neuron to a corresponding second artificial neuron in the brain emulation neural network architecture. The connection pointing from the first artificial neuron to the second artificial neuron may indicate that the output of the first artificial neuron should be provided as an input to the second artificial neuron. Each connection in the brain emulation neural network architecture may be associated with a weight value, e.g., that is specified by the weight value associated with the corresponding edge in the brain emulation graph. An artificial neuron may refer to a component of the brain emulation neural network architecture that is configured to receive one or more inputs (e.g., from one or more other artificial neurons), and to process the inputs to generate an output. The inputs to an artificial neuron and the output generated by the artificial neuron may be represented as scalar numerical values. In one example, a given artificial neuron may generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the brain emulation graph 410 may be an undirected graph, and the architecture mapping engine 404 may map an edge that connects a first node to a second node in the brain emulation graph 410 to two connections between a corresponding first artificial neuron and a corresponding second artificial neuron in the brain emulation neural network architecture. In particular, the architecture mapping engine 404 may map the edge to: (i) a first connection pointing from the first artificial neuron to the second artificial neuron, and (ii) a second connection pointing from the second artificial neuron to the first artificial neuron.

In another example, the brain emulation graph 410 may be an undirected graph, and the architecture mapping engine may map an edge that connects a first node to a second node in the brain emulation graph 410 to one connection between a corresponding first artificial neuron and a corresponding second artificial neuron in the brain emulation neural network architecture. The architecture mapping engine may determine the direction of the connection between the first artificial neuron and the second artificial neuron, e.g., by randomly sampling the direction in accordance with a probability distribution over the set of two possible directions.

In another example, the brain emulation neural network architecture may include: (i) a respective artificial neural network layer corresponding to each node in the brain emulation graph 410, and (ii) a respective connection corresponding to each edge in the brain emulation graph 410. In this example, a connection pointing from a first layer to a second layer may indicate that the output of the first layer should be provided as an input to the second layer. An artificial neural network layer may refer to a collection of artificial neurons, and the inputs to a layer and the output generated by the layer may be represented as ordered collections of numerical values (e.g., tensors of numerical values). In one example, the brain emulation neural network architecture may include a respective convolutional neural network layer corresponding to each node in the brain emulation graph 410, and each given convolutional layer may generate an output d as:

$$d = σ ( {h}_{θ} ( {\sum }_{i = 1}^{n} {w}_{i} \cdot {c}_{i} ) ) \qquad ( 2 )$$

where each c₁ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each connection may be specified by the weight value associated with the corresponding edge in the brain emulation graph), h_{θ}(⋅) represents the operation of applying one or more convolutional kernels to an input to generate a corresponding output, and σ(⋅) is a non-linear activation function that is applied element-wise to each component of its input. In this example, each convolutional kernel may be represented as an array of numerical values, e.g., where each component of the array is randomly sampled from a predetermined probability distribution, e.g., a standard Normal probability distribution.

In another example, the architecture mapping engine may determine that the brain emulation neural network architecture includes: (i) a respective group of artificial neural network layers corresponding to each node in the brain emulation graph 410, and (ii) a respective connection corresponding to each edge in the brain emulation graph 410. The layers in a group of artificial neural network layers corresponding to a node in the brain emulation graph 410 may be connected, e.g., as a linear sequence of layers, or in any other appropriate manner.

The brain emulation neural network architecture 414 may include one or more artificial neurons that are identified as “input” artificial neurons and one or more artificial neurons that are identified as “output” artificial neurons. An input artificial neuron may refer to an artificial neuron that is configured to receive an input from a source that is external to the brain emulation neural network. An output artificial neural neuron may refer to an artificial neuron that generates an output which is considered part of the overall output generated by the brain emulation neural network. The architecture mapping engine may add artificial neurons to the brain emulation neural network architecture in addition to those specified by nodes in a brain emulation graph, and designate the added neurons as input artificial neurons and output artificial neurons. For example, for a brain emulation neural network that is configured to process an input including a 100×100 array of values to generate an output including an array of 1000 values, the architecture mapping engine may add 10,000 (=100×100) input artificial neurons and 1000 output artificial neurons to the brain emulation neural network architecture. Input and output artificial neurons that are added to the brain emulation neural network architecture may be connected to the other neurons in the architecture in any of a variety of ways. For example, the input and output artificial neurons may be densely connected to every other neuron in the architecture.

For each brain emulation neural network architecture 414, the training engine 406 instantiates a drone control neural network 416 implemented as a reservoir computing neural network and that includes a brain emulation sub-network having the brain emulation neural network architecture 414. Examples of a drone control neural network that includes a brain emulation sub-networks is described in more detail with reference to FIG. 2. Each drone control neural network 416 is configured to perform a drone control processing task, e.g., a prediction task or an auto-encoding task. In a prediction task, the drone control neural network is configured to process sensor data to generate a prediction characterizing the sensor data, e.g., in the form of an action for operation of the drone, as described above. In an auto-encoding task, the drone control neural network can be training to process sensor data as input and generate an output that reconstructs the input using standard supervised learning techniques (e.g., by optimizing a squared-error objective function by back-propagating gradients of the objective function into the output sub-network and the input sub-network of the drone control neural network).

The training engine 406 is configured to train each drone control neural network 416 to perform a drone control processing task over multiple training iterations. Training a drone control neural network that includes a brain emulation sub-network to perform a prediction task is described with reference to FIG. 2. Training a drone control neural network to perform an auto-encoding task proceeds similarly, except that the objective function being optimized measures an error between: (i) sensor data, and (ii) a reconstruction of the sensor data that is generated by the drone control neural network.

The training engine 406 determines a respective performance measure 412 of each drone control neural network 416 on the sensor data processing task. For example, if the sensor data processing task is a drone control task, then the training engine 406 can use each drone control neural network to control the drone to perform a set of tasks (e.g., landing the drone at various simulated landing sites). The training engine 406 can then determine a performance measure 412 for each drone control neural network based on a cumulative measure (e.g., sum) of rewards received when the drone is controlled by the drone control neural network. As another example, the training engine 406 may determine the performance measure 412 for each drone control neural network based on a respective error between: (i) the output generated by the drone control neural network for the sensor data, and (ii) a target output for the sensor data, for each set of sensor data in a validation set. For a prediction task, the target output for a set of sensor data may be, e.g., a target control signal output, e.g., generated by a conventional drone control system. For an auto-encoding task, the target output for a set of sensor data may be the same set of sensor data. The training engine 406 may determine the performance measure 412, e.g., as the average error or the maximum error over respective sets of sensor data in the validation set.

The selection engine 408 uses the performance measures 412 to generate the output brain emulation neural network 108. In one example, the selection engine 408 may generate a brain emulation neural network 108 having the brain emulation neural network architecture 414 associated with the best (e.g., highest) performance measure 412.

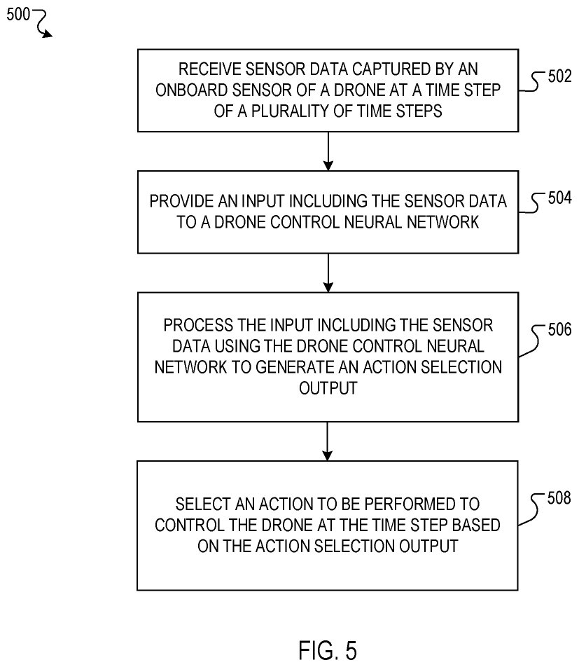

FIG. 5 is a flow diagram of an example process 500 for processing sensor data using a drone control neural network to generate a prediction characterizing the sensor data for each of multiple time steps. For convenience, the process 500 will be described as being performed by a system of one or more computers located in one or more locations. For example, a drone control system, e.g., the drone control system 200 of FIG. 2, appropriately programmed in accordance with this specification, can perform the process 500.

The system receives sensor data captured by an onboard sensor of a drone at a time step of multiple time steps (502). In some implementations, the system receives sensor data, e.g., gyroscopic data, captured by an onboard sensor, e.g., gyroscope, of a drone in real-time and at particular sampling rate, e.g., at least 1 Hz, at least 5 Hz, etc. The sensor data is processed by the system at a rate faster than the sampling rate of gyroscopic data from the gyroscope, such that the system generates a prediction for each set of sensor data before the next set of sensor data is sampled. Predictions generated by the system can be utilized by drone control software to generate real-time control signals for a navigation system of the drone, e.g., operation of one or more propellers, to land the drone.

As described above, sensor data can include multiple channels of sensor data, for example, sensor data can be gyroscopic data including amplitude of displacement, amplitude of velocity, and amplitude of acceleration. In some implementations, sensor data can include measurements collected from multiple of a same type of sensor, e.g., multiple gyroscopes located at different points onboard the drone, and/or measurements collected from multiple different types of sensors, e.g., a gyroscope, an anemometer, a temperature gauge, etc.

The system provides an input including the sensor data to a drone control neural network (504). In some implementations, the system provides the sensor data to an input sub-network to generate an embedding of the sensor data. The sensor data can include multiple channels of data, e.g., amplitude of displacement, amplitude of velocity, and amplitude of acceleration, which can each be provided to the input sub-network to generate a respective embedding of each of the multiple channels of sensor data.

In some implementations, the system includes a pre-processing step performed on the sensor data. In one example, the pre-processing includes a low-pass filtering step on the sensor data.

The system processes the input including the sensor data using the drone control neural network to generate an action selection output (506).

The values of at least some of the brain emulation sub-network parameters may be determined before the reservoir computing neural network is trained and not be adjusted during training of the reservoir computing neural network. The brain emulation sub-network has a neural network architecture that is specified by a brain emulation graph, where the brain emulation graph is generated based on a synaptic connectivity graph representing synaptic connectivity between neurons in a brain of a biological organism. The synaptic connectivity graph specifies a set of nodes and a set of edges, where each edge connects a pair of nodes, each node corresponds to a respective neuron in the brain of the biological organism. Each edge connecting a pair of nodes in the synaptic connectivity graph may correspond to a synaptic connection between a pair of neurons in the brain of the biological organism.

In some implementations, as described with reference to FIG. 2, the system processes the output of the brain emulation sub-network using an output sub-network of the reservoir computing neural network to generate a prediction characterizing the sensor data. The prediction may be, for example, a control signal for operating the navigation system of the drone, e.g., a propeller speed/direction of rotation, tip/tilt of the propeller, etc.

The system selects an action to be performed to control the drone at the time step based on the action selection output (508). The selected action can include a course correction on a flight path of the drone, for example, control signals for operating a propeller assembly of the drone. For example, control signals can include an adjustment to a speed of propeller operation, a direction of rotation of the propeller, a tip/tilt of the propeller, or a combination thereof.

In some implementations, the system can receive an image captured by an onboard camera of the drone including a safe landing area designated within the image, such that a selected action includes a course correction to land the drone within the safe landing area, e.g., as described with reference to FIG. 3.

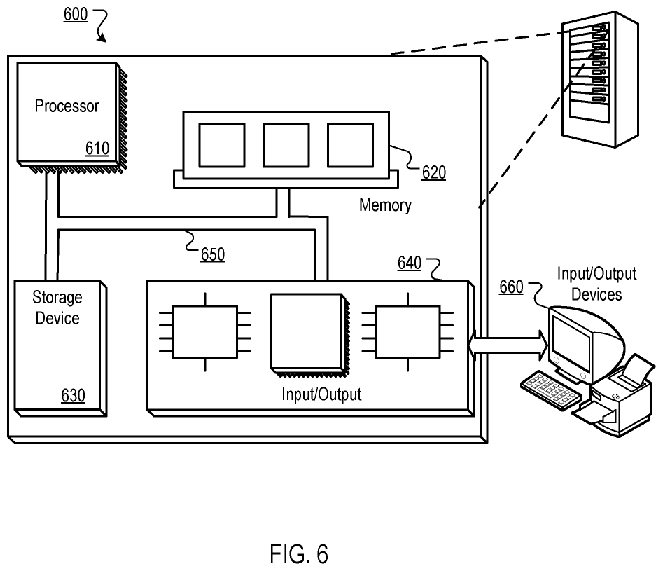

FIG. 6 is a block diagram of an example computer system 600 that can be used to perform operations described previously. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (for example, a cloud storage device), or some other large capacity storage device.

The input/output device 640 provides input/output operations for the system 600. In one implementation, the input/output device 640 can include one or more network interface devices, for example, an Ethernet card, a serial communication device, for example, and RS-232 port, and/or a wireless interface device, for example, and 802.11 card. In another implementation, the input/output device 640 can include driver devices configured to receive input data and send output data to other input/output devices, for example, keyboard, printer and display devices 660. Other implementations, however, can also be used, such as mobile computing devices, mobile communication devices, and set-top box television client devices.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus for controlling a drone navigating in an environment, the method comprising, at each of a plurality of time steps:
receiving sensor data captured by an onboard sensor of a drone at the time step;
providing an input comprising the sensor data to a drone control neural network having a brain emulation sub-network with an architecture that is specified by synaptic connectivity between neurons in a brain of a biological organism, wherein specifying the brain emulation sub-network architecture comprises:
instantiating a respective artificial neuron in the brain emulation sub-network corresponding to each biological neuron of a plurality of biological neurons in the brain of the biological organism; and
instantiating a respective connection between each pair of artificial neurons in the brain emulation sub-network that correspond to a pair of biological neurons in the brain of the biological organism that are connected by a synaptic connection; and
processing the input comprising the sensor data using the drone control neural network having the brain emulation sub-network to generate an action selection output; and
selecting an action to be performed to control the drone at the time step based on the action selection output.

2. The method of claim 1, wherein the onboard sensor comprises a gyroscope and the sensor data comprises gyroscopic data.

3. The method of claim 2, wherein the gyroscopic data comprises an amplitude of displacement, an amplitude of velocity, and an amplitude of acceleration.

4. The method of claim 1, wherein the drone control neural network comprises an input sub-network, and wherein processing the input comprising the sensor data using the drone control neural network comprises:
processing the sensor data using the input sub-network to generate an embedding of the sensor data; and
providing the embedding of the sensor data to the brain emulation sub-network of the drone control neural network.

5. The method of claim 4, wherein the drone control neural network comprises an output sub-network, and wherein processing the input comprising the sensor data using the drone control neural network further comprises:
processing the embedding of the sensor data using the brain emulation sub-network to generate an alternative representation of the sensor data; and
processing the alternative representation of the sensor data using the output sub-network to generate the action selection output.

6. The method of claim 5, further comprising:
receiving a respective reward at each of the plurality of time steps that characterizes a performance of the drone in accomplishing a task; and
training the input sub-network and the output sub-network of the drone control neural network based on the rewards using reinforcement learning techniques.

7. The method of claim 6, wherein the task comprises navigating to a specified destination, hovering at a specified location, or landing in a specified landing area.

8. The method of claim 7, wherein the task is landing in the specified landing area, and wherein the respective reward received at each of the plurality of time steps when the drone lands in the specified landing area is based on a proximity of a landing position of the drone to a center of the specified landing area.

9. The method of claim 5, further comprising:
identifying a respective target action selection output at each of the plurality of time steps; and
training the input sub-network and the output sub-network of the drone control neural network to generate a respective action selection output at each time step that matches the target action selection output for the time step.

10. The method of claim 1, wherein the action selection output comprises a respective score for each action in a set of possible actions that can be performed by the drone.

11. The method of claim 10, wherein selecting the action to be performed to control the drone at the time step based on the action selection output comprises:
selecting an action corresponding to a highest score in the action selection output.

12. The method of claim 1, wherein the action selection output defines an action that can be performed by the drone, and wherein selecting the action to be performed to control the drone at the time step based on the action selection output comprises:
selecting the action that is defined by the action selection output as the action to be performed to control the drone at the time step.

13. The method of claim 1, wherein the action to be performed to control the drone at the time step comprises an action to control a respective speed, tip/tilt, or rotation direction of one or more propellers of the drone.

14. The method of claim 1, wherein the action selection output defines a course correction to a flight path of the drone, and wherein selecting the action to be performed by the drone at the time step based on the action selection output comprises:
selecting an action to be performed by the drone to achieve the course correction to the flight path of the drone.

15. The method of claim 1, wherein specifying the brain emulation sub-network architecture further comprises, for each pair of artificial neurons in the brain emulation sub-network that are connected by a respective connection:
instantiating a weight value for the connection based on a proximity of a pair of biological neurons in the brain of the biological organism that correspond to the pair of artificial neurons in the brain emulation sub-network.

16. The method of claim 15, wherein the weight values of the brain emulation sub-network are static during training of the drone control neural network.

17. The method of claim 1, wherein the drone control neural network is implemented by an onboard computer system of the drone.

18. The method of claim 1, wherein the environment is a simulated environment.

19. A system for controlling a drone navigating in an environment, comprising:
one or more computers; and
one or more storage devices communicatively coupled to the one or more computers, wherein the one or more storage devices store instructions that, when executed by the one or more computers, cause the one or more computers to perform operation comprising:
receiving, at each of a plurality of time steps, sensor data captured by an onboard sensor of a drone at the time step;
providing an input comprising the sensor data to a drone control neural network having a brain emulation sub-network with an architecture that is specified by synaptic connectivity between neurons in a brain of a biological organism, wherein specifying the brain emulation sub-network architecture comprises:
instantiating a respective artificial neuron in the brain emulation sub-network corresponding to each biological neuron of a plurality of biological neurons in the brain of the biological organism; and
instantiating a respective connection between each pair of artificial neurons in the brain emulation sub-network that correspond to a pair of biological neurons in the brain of the biological organism that are connected by a synaptic connection; and
processing the input comprising the sensor data using the drone control neural network having the brain emulation sub-network to generate an action selection output; and
selecting an action to be performed to control the drone at the time step based on the action selection output.

20. One or more non-transitory computer storage media storing instructions that when executed by one or more computers cause the one or more computers to perform operations comprising:
receiving, at each of a plurality of time steps, sensor data captured by an onboard sensor of a drone at the time step;
providing an input comprising the sensor data to a drone control neural network having a brain emulation sub-network with an architecture that is specified by synaptic connectivity between neurons in a brain of a biological organism, wherein specifying the brain emulation sub-network architecture comprises:
instantiating a respective artificial neuron in the brain emulation sub-network corresponding to each biological neuron of a plurality of biological neurons in the brain of the biological organism; and
instantiating a respective connection between each pair of artificial neurons in the brain emulation sub-network that correspond to a pair of biological neurons in the brain of the biological organism that are connected by a synaptic connection; and
processing the input comprising the sensor data using the drone control neural network having the brain emulation sub-network to generate an action selection output; and
selecting an action to be performed to control the drone at the time step based on the action selection output.
